(19) United States
(12) Patent Application Publication
(10) Pub. No.: US 2011/0217480 A1
(43) Pub. Date: Sep. 8, 2011

(54) Structure for resting furniture

(75) Inventor: Fabio Salvadori, Casciana Terme (IT)

(73) Assignees: Fabio Salvadori, Casciana Terme (IT); Federico Salvadori, Casciana Terme (IT); Luciano Salvadori, Casciana Terme (IT); Simone Salvadori, Casciana Terme (IT)

(21) Appl. No.: 13/129,112

(22) PCT Filed: Nov. 16, 2009
(86) PCT No.: PCT/IB2009/007471

§ 371 Date: May 12, 2011

(30) Foreign Application Priority Data
Nov. 18, 2008 (IT) PCT/IT2008/000717

(51) Int. Cl. B05D 3/06; B05D 3/12

(52) U.S. Cl. 427/532; 427/299

(57) ABSTRACT

The present invention relates to a method for the realization of a structure for couches, beds, mattresses, chairs and the like. In particular, in accordance with a first embodiment, operations are foreseen that include the processing in machine tools of a single mono-block in such a way as to obtain a monolithic final structure. A superficial treatment of the structure thus obtained may be included. A second embodiment relates to the processing of one or more monolithic blocks to obtain many parts that are subsequently combinable with each other to obtain the final structure. In that case, a superficial treatment can be included to join the parts with each other and provide the mechanical features to the material, or, alternatively, the superficial treatment of the single parts and subsequent combination with each other can be performed. A shape-memory polymer composite material is of particular interest for the present application.

### TECHNICAL FIELD

The present invention refers to the technical field of furniture in general. In particular, it refers to a new method of producing structures suitable for the creation of resting furniture for people, particularly couches, beds, mattresses, chairs and the like.

A structure produced with such a method is also described herein.

### STATE OF THE ART

Processing techniques for producing couches, beds and furniture components in general configured specifically for human rest have long been known. By way of example, a realization technique of a couch (but also for other kinds of components) is described below, which involves different processing steps that are extremely complex and expensive.

First, according to a first processing step, a supporting framework must be realized configured to give the couch the right rigidity and weight bearing capacity. It is required that the couch be capable of bearing the weight of the people that are seated or lying down on it. Only afterwards, around the structure so realized, an appropriate padding is built. Once this operation is done, the couch is finally covered with the preselected linings, for example of leather or common synthetic fabrics or cotton.

According to the state of the art, the production of the framework can be done according to different techniques. For example, a common technique is a production in metal, which is done by combining tubes and springs. In other cases, one can be indifferently use a combination of panels and wood laths (plywood, etc.). A combination of metal and wood together or similar materials is also possible. In the case of the production of beds, however, it is necessary to provide mattress and structure separately. In particular, for the production of the mattress it is necessary to assemble the springs to create the structure around which to lay the padding. In particular, an appropriate supporting surface is realized that is constituted by the springs in metal, wood or by a combination of these materials.

As described in patent CH696958 A5, a structure of a chair is obtained through the coupling of different parts produced separately, namely a back 5, a seat 2 and arms 6 and 7.

This method of production is traditional and is not free from significant inconveniences, which will be described below.

First, each part composing the final structure need to foresee joints (for example, gains) capable of allowing the coupling between the parts and capable of supporting the weight of the user. The provision of joints significantly complicates the production of each single part. Moreover, each part must have the appropriate dimensions so as not to incur break risks.

The production of a framework (no matter whether of a couch or of any other resting component) is practically an operation that does not lend itself to a complete automation and always requires the presence of the human hand, being a work of handicraft nature most of the times, also for productions that are part of pre-established series. The tubes (or laths and panels in a totally indifferent manner), after they have been custom cut, must be opposed and fixed to each other according to predetermined geometries that must contribute to creating the final shape. It is clear how such composition process is hardly feasible exclusively by machines exclusively (both from the technological and economic point of view), especially if the design is variable within a broad series of possible geometries. These approaches indeed involve a remarkable number of weldings of the parts until the definite shape is obtained. It is clear how also this operation requires practically a work of handicraft nature with the continuous presence of the human hand. Indeed, also in the case in which more or less automated welding machines are used, it is anyway necessary to have a human presence to oppose the parts, create the final geometries, and to control anyway the quality of the welding between the parts. What has been said is also directly connected with the “numbers”, though limited, of pieces to manufacture.

It is at this point clear how in this technical field the manufacture of products is extremely expensive. Indeed, it is clear how useful an industrialization would be, which cannot be introduced beyond a certain point without having as a significant increased in costs. Because a totally automated mass production is not possible, production costs remarkably increase against a quantity of pieces realized that is very low.

Another problem, not less important than the one described, refers to the non rare case in which the customer requests variations on the standard design. In this case, all the more so, the production costs increase further as it is necessary to cut the pieces into dimensions that are different from the standard ones and then proceed with the welding of the same according to geometries that can be different from the ones that are commonly used.

Moreover, the handicraft features of the production remarkably bear on the so called “Lead Time”, or rather the time it takes to delivery the product. Indeed, to stock storehouses with products even partially pre-assembled to gain time in the production described above has a cost that is too high. For this reason, the production of each piece actually always starts from the beginning. This implies a significantly lower quantity of production and longer waiting times for the client. Obviously, this often means lower earnings or delays in cash receipts.

Last but not least, another problem (anyway common in general to all fields of production in this sector) concerns the transportation. The company that produces the frameworks of the couches, or of other furniture, is often an external company in respect to the one that produces the final padding process. In this case, it is necessary to organize the transportation towards the final production place. It is clear how the frameworks, tracing the final shape of the couch, result to be extremely cumbersome. This implies high costs for the transportation, especially if compared to the value of the transported structures, given that each truck is capable of containing a relatively limited number of pieces. It is clear how also the transportation bears on the production costs in an important manner, with a consequent increase in selling costs.

### DISCLOSURE OF INVENTION

It is therefore the aim of the present invention to provide a new furniture production method useful for human rest, particularly couches, beds, mattresses/bed bases, chairs and the like that resolves all the above inconveniences.

It is therefore the aim of the present invention to provide a new method of production of a base supporting structure that lends itself to a complete automation, increasing production remarkably.

In particular, it is the aim of the present invention to eliminate entirely the assembly steps of many parts structural to each other (for example, by welding) for the production of a final structure, thus economizing on the production times.

It is also the aim of the present invention to provide a method that allows the production of a base structure of which its superficial hardness or softness, as well as its overall mechanical features are controllable.

It is also the aim of the present invention to provide a production method that does not need the provision of joints between parts that are appropriately dimensioned.

These and other aims are therefore reached with the present method for the production of a base structure for couches, beds, mattresses/bed bases, chairs and the like that includes the following steps:

Arrangement of a single mono-block (1);

Processing by machine tools (4) of the full mono-block, according to a predetermined processing cycle, so as to obtain a monolithic final base structure (7).

According to this method, the use of a generic solid body (of predetermined shape and volume) allows a process by machine tools similar to the mechanical-type standard process but applied in an innovative manner in a completely new technical field. Thus, it is possible to automate the production of a shape of a final structure 7 without resorting anymore to long operations of assembling or combination by glueing or welding of laths or tubes of handicraft type. Therefore, the realization of complex joints between the parts is not necessary anymore. Thus, the operator can use the machines according to specific processing cycles in order to process the body (represented by a single starting piece placed on the machines) according to the desired shape. It is therefore clear, according to this method, how the production can be remarkably increased, reducing the so-called “Lead Time”. This is also applicable in the same manner to the production, for example, of a base structure for couches, and for mattresses/bed bases, chairs or resting furniture in general, and even for urban furnishings (benches, etc.).

Advantageously, it is possible to further foresee an operation of superficial treatment of the final structure (7) thus obtained.

Such superficial treatment provides the structure as a whole with particular mechanical features, and it also allows a control of the superficial hardness or softness.

Advantageously, a finishing phase of the final structure (7) is further foreseen, both at the end of the processing by machine tools and possibly after the possible superficial treatment.

The finishing allows to eliminate processing imperfections as well as deformations due to the possible superficial treatment.

Advantageously, the superficial treatment can comprise at choice one or more in combination between them of the following operations:

Superficial spraying;

Spraying and accretion;

Injection;

Chemical and/or thermal treatment;

Specific radiations.

The treatment with specific radiations can concern the surface of the solid body as well as the body (or part) of the monolith.

Advantageously, the operations of superficial spraying and spraying-accretion comprise the spraying of a polymeric material (through for example the use of common nozzles (8)) on a part or the entire surface of the final structure (7) obtained in such a way as to realize an external covering (11).

The external covering (11), once hardened, acquires particular mechanical features. For example, it can in fact constitute the supporting structure of the structure 7 that wraps and provides particular hardness or softness in its external areas designed to contact with the user.

The mechanical features of the external covering are controllable through, for example, the composition of the polymer used, as well as the thickness 11 sprayed.

Advantageously, the operation of injection can comprise the injection into a part or the entire final structure (7) of a polymeric material of expansible type in such a way that, after the expansion through the porosities of the final structure (7), an external covering (11) is formed that penetrates also internally.

Likewise, the treatment by specific radiation allows altering the features of the processed body.

In the above cases of superficial treatment, the polymer used may be a polyurethane material composed of predetermined percentages of Polyol and Isocyanate.

A polymer with features of shape memory can possibly be utilized.

Advantageously, the operation of processing by machine tools can comprise the programming of machineries according to one of the following choices:

Programming of numerical control machines;

Programming of electro-mechanical machines;

Radiations.

Advantageously, the numerical control machines may include chip removal and the processing cycle comprises at least an operation of milling by means of an appropriate milling cutter (6) or the like.

In that case, arranging the mono-block on the machines, these can be suitably programmed to obtain the desired processing cycles.

In the case in which electro-mechanical machines are used, these advantageously make cuts to generate the surfaces of the structure according to one or more of the following methods:

Mechanical cut method;

Specific radiations cut method;

High pressure liquid/gas mixtures cut method.

Among the various possible choices of material, the mono-block (1) can be advantageously a composite material, preferably a composite material of the polymeric type with shape memory.

Advantageously, the material with shape memory has a glass transition temperature Tg so as to assume a second shape after heating at a temperature that is higher than the Tg temperature and subsequent cooling below this temperature, maintaining it in the deformed configuration by means of an external force. The polymeric material, having memory of its original shape, can rebuild its original shape after the subsequent heating above the Tg temperature in the absence of the external constraint force.

Advantageously, the choice of the material with shape memory can be such that the glass transition temperature Tg results to be a temperature equal to or higher than 50° C. (Centigrade degrees).

Advantageously, at the end of the above operations of mono-block (1) processing by machine tools (4) and possible superficial treatment, in the case of mono-block of material with shape memory, the following further operations are possible:

Heating the structure above the Tg temperature;

Deformation according to a predetermined shape;

By subsequent cooling below the transition temperature maintaining the deformed configuration by means of appropriate compression means, the said cooling stabilizing the deformed shape.

This process allows a remarkable reduction of the dimensions of the semi-finished product, making both the eventual transportation and the storage in general of the product economical and extremely convenient. Thus, this allows maintaining the storehouses always full of products in contained spaces, assuring in this way a continuous supply of the product and eliminating entirely the time losses connected with a single production for each new purchase order received and moreover, reducing transportation costs.

Advantageously, the deformation operation of the structure can comprise the compaction of the dimensions with an appropriate press.

Advantageously, the volume reduction can comprise one of the following choices:

Reduction of half of the original volume;

Reduction of a quarter of the original volume;

Reduction inferior to a quarter of the original volume.

Advantageously, the compaction operation deforms the structure 7 into a cubic form of reduced volume with respect to the original shape.

Advantageously, after the deformation and cooling operation, the further heating over the Tg temperature to rebuild the original shape of the structure is foreseeable.

In accordance with the first choice described, the processing of a single monolithic piece (1) for obtaining the monolithic base structure is therefore possible. Thus, it is clear how a single processing cycle produces the final structure eliminating entirely the inconveniences of assembling, for example, by welding according to the state of the art and by critical joints.

Nevertheless, a second possibility can comprise an arrangement and processing of one or more mono-blocks for obtaining parts capable of being afterwards assembled for obtaining the final base structure 7.

Therefore, in accordance with an alternative embodiment of the present invention, there is further described herein a method for the realization of a base structure for couches, beds, mattresses/bed bases, chairs and the like, which comprises the operations of:

Processing by machine tools (4) of one or more mono-blocks (1) according to predetermined processing cycles in such a way as to obtain a plurality of parts (7′, 7″) subsequently combinable with each other;

Combination between them of the parts for obtaining a final base structure (7).

In that case, however, a further operation of superficial treatment of the final base structure 7 is foreseen, and the spraying and/or spraying and accretion and/or injection of a polymeric material in such a way as to realize an external covering (11).

In that case, therefore, not only does the superficial treatment provide the above mechanical features to the final structure 7 but also realizes a stable connection between the parts. It is therefore not necessary anymore to arrange for each single part of complex attachment systems such as particular shapings, gains and/or adhesives, being such a function fully accomplished by the superficial treatment. Therefore, also through the realization of many parts to be combined with each other, the use of the superficial treatment significantly simplifies the production of such parts.

The sprayed polymeric material can, also in this case, be possibly of the shape memory type.

Alternatively, before the operation of combination of the parts (7′, 7″), an operation of superficial treatment of one or more of the above parts through the spraying and/or spraying and accretion and/or injection of a polymeric material can be foreseen in such a way as to realize an external covering (11).

In that case, the parts are then combined with each other only after the above superficial treatments and through the use of bolts and/or glueing.

In this case, the final structure 7 obtained will anyway have all the mechanical features provided by the superficial treatment.

Also in this case, a thermal/chemical treatment is foreseeable.

Also in this case, the processing operation by machine tools can naturally comprise the programming of machineries according to one of the following choices:

Programming of numerical control machines;

Programing of electro-mechanical machines;

Radiations.

As already said, the numerical control machines provide for chip removal with a processing cycle that comprises at least an operation of milling by means of appropriate milling cutter (6).

Alternatively, the electro-mechanical machines produce cuts that generate the surfaces of the structure according to one or more of the following methods:

Mechanical cut method;

Specific radiations cut method;

High pressure liquid/gas mixtures cut method.

Advantageously, also in this case, one or more mono-blocks (1) can be of a composite material, particularly of a polymeric composite material with shape memory.

The final product obtained from them can therefore be compacted and rebuilt to the original shape exactly with the same methods described for the above first embodiment.

### BRIEF DESCRIPTION OF THE DRAWINGS

Further features and advantages of the present method of processing a structure for couches, beds, mattresses, chairs and the like, according to the invention, will be clearer with the description of two embodiments that follows, made to illustrate but not limit, with reference to the annexed drawings, wherein:

FIG. 1 represents a solid body of a material in general and its arrangement on a machine tool;

FIG. 2 represents schematically a processing phase by machine tools according to a predetermined processing cycle;

FIG. 3 represents schematically a possible superficial treatment by spraying or spraying and accretion and a section that highlights the finished product after the treatment;

FIG. 4 represents a superficial treatment by injection while FIG. 5 represents a superficial treatment of the thermal and/or chemical type;

FIG. 6 and FIG. 7 represent a further shape of the invention wherein the processing of the mono-block or mono-blocks is described to obtain parts of base structure that make up sectional furniture.

FIG. 8 represents heating and cooling cycles to deform the base structure obtained if this is realized through the use of polymers with shape memory;

FIG. 9 represents a restoration of the original shape.

### DESCRIPTION OF SOME EMBODIMENTS

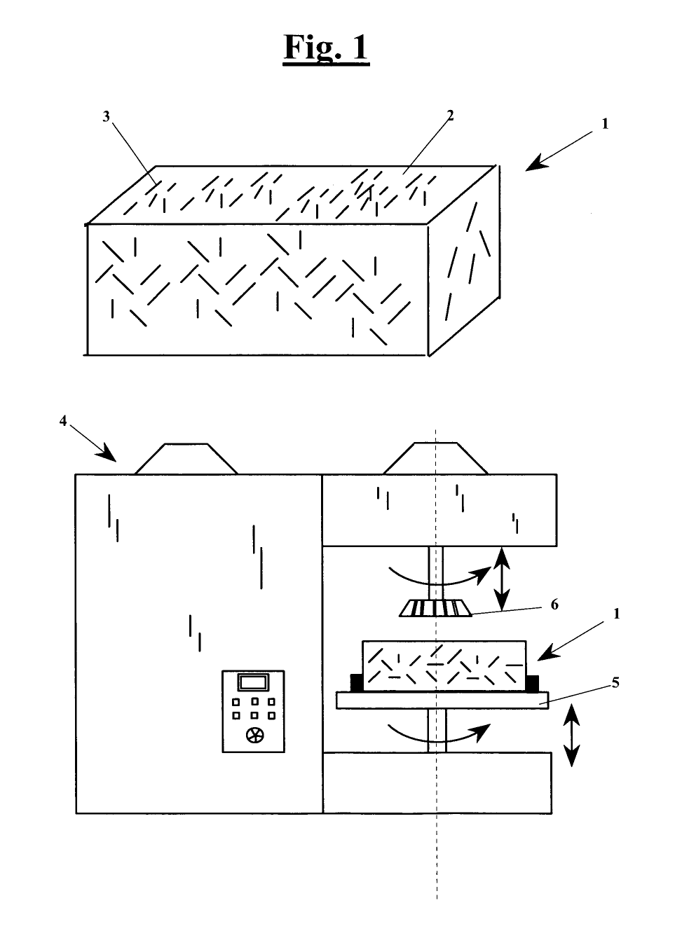

With reference to FIG. 1, the present innovative method for the production of base structures constituting the framework of couches, mattresses/bed bases, beds, armchairs in general and the like is described, according to a first embodiment of the invention.

Only for descriptive simplicity, and in an absolutely non imitating manner, the reference drawings describe the production of a base structure 7 for couches. The present description, as said, can anyway be applied to other structures of furniture in general (for example, mattresses) without for this moving apart from the present inventive concept.

As described in FIG. 1, the different processing phases foresee, first of all, the arrangement of a single mono-block 1, or body 1, of a shape and material absolutely generic.

In FIG. 1 the mono-block 1 is therefore represented, in a non limiting manner, according to an original shape corresponding to a parallelepiped. The parallelepiped is therefore positioned on appropriate machine tools 4 in such a way that, through a predetermined processing cycle, it is possible to obtain the monolithic final shape 7 (in a sole piece) of the structure starting from the full original mono-block.

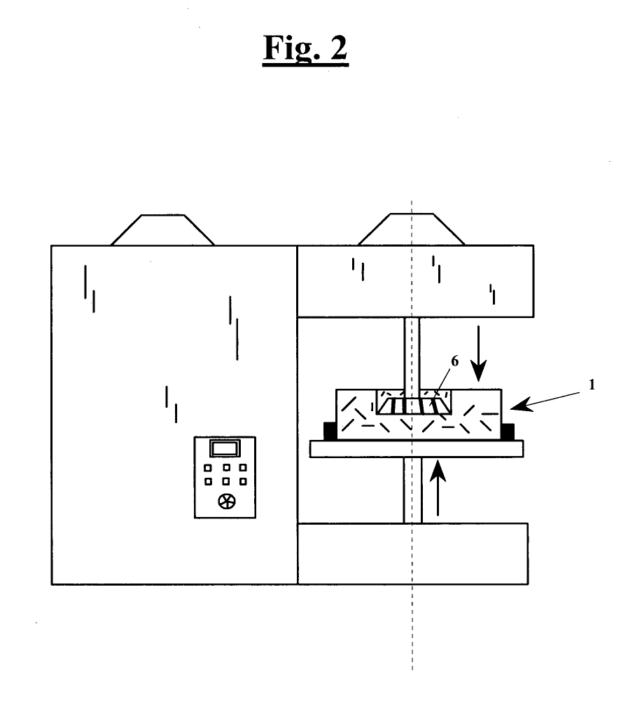

Still as represented in FIG. 1 and FIG. 2, the mono-block 1 is therefore positioned on the work-bench 5 of the machine 4. In this case, according to a possible processing cycle, the milling cutter 6 (which has suitable features for the processing of the material in terms of constitutive material, geometry, tool cooling, etc.), mills the material, realizing the specific geometries. Only by way of example, the milling cutter represented in FIG. 2 realizes the seat and the back of the couch by milling the mono-block 1.

Defining, therefore, predetermined processing programs (also on types of machines placed in series production) fully automated processing cycles can be performed, producing not only base structures for couches, but rather a broad range of products comprising mattresses/bed bases, beds, armchairs, chairs and the like.

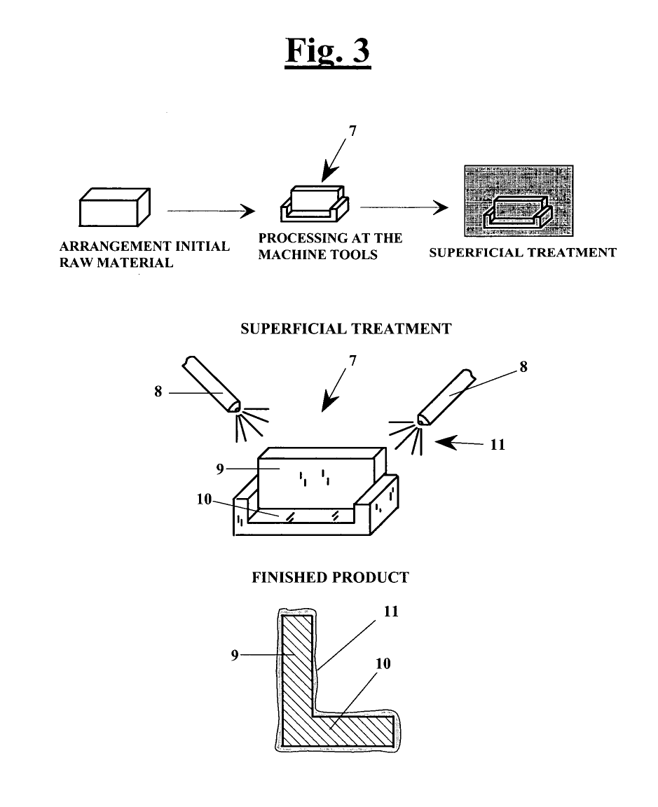

As described in FIG. 3, after processing by machine tools, it is possible to perform a further step of superficial treatment of the final structure 7 obtained thereby.

A first possible treatment comprises an operation of spraying generally a polymeric material, preferably of the polyurethane type. Polyurethane, as it is well known, is a material composed of the mixture of two components, the “Polyol” and the “Isocyanate”, in pre-established percentages.

Possibly, a polymer with shape memory can be used (as also detailed in the description below).

FIG. 3, for greater clarity, schematizes this processing phase wherein one or more nozzles 8 spray the polymer 11 in a substantially fluid manner on the base structure 7 obtained. The polymer, after the spraying, wraps the structure and hardens, realizing an external covering 11, similar to a shell or bark, that covers the parts in which it has been sprayed. In that sense, it can perfectly be sprayed just on one part or on the entire structure 7 in its totality. Thus, the structure 7 will acquire particular mechanical features (mechanical resistance) of hardness or softness on the basis of the base composition of the sprayed polymer. FIG. 3 also shows, for clarity purposes, a section of the couch that shows back 9 and seat 10, wherein the covering 11 of hardened polymeric material around the structure 7 is highlighted.

A second equivalent technique concerns the choice of spraying and accretion. This is different from the previous one exclusively because the used polymer will also have expansion features in the course of time capable of providing the structure on which it has been sprayed with further particular mechanical features.

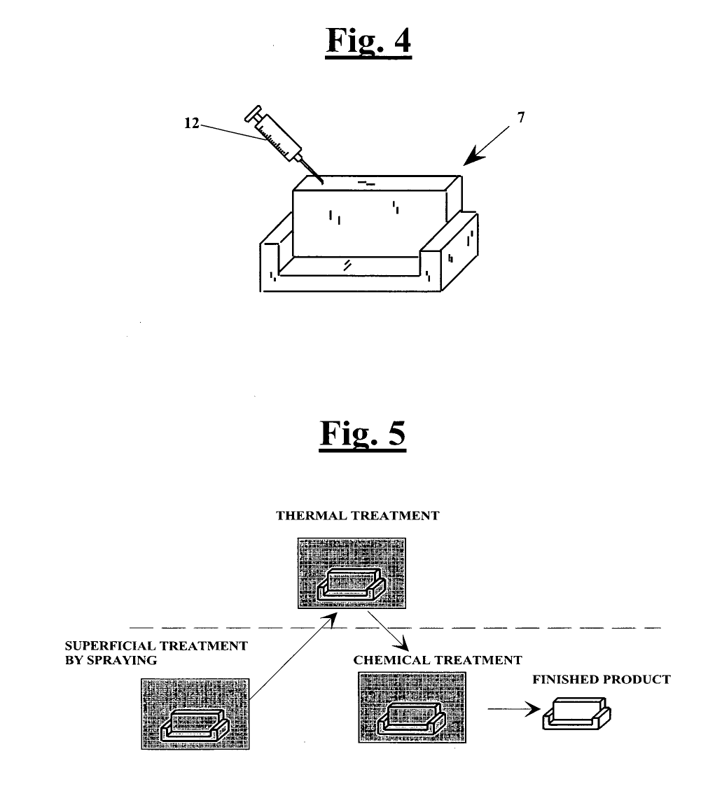

A third possibly applicable technique is that of the injection in one or more steps of the polymeric material. FIG. 4 schematizes such a technique, which consists in injecting into the structure 7 the polymeric material, for example in the form of foam. The material penetrates in the superficial layers through the porosity of the material and, after expansion, exits towards the exterior, always through the pores. The final result is therefore very similar to that represented in FIG. 3, wherein a certain degree of internal penetration has taken place. Also in this case, by controlling the type of polymer injected, the degree of hardness or softness of the covering of the structure obtained can be controlled in the spots wherein the polymer has been injected. Just for schematization purposes, FIG. 4 represents a syringe 12 with which the phase of injection of the polymer is represented.

In all cases, the external covering 11 realized can have variable thicknesses according to a wide range from one milimeter to more than 10 centimeters of thickness and even more.

A fourth option consists in a superficial treatment of chemical and/or thermal type. In that case, the spraying of other chemical agents different from the polymer and residence in an oven at a suitable temperature so as to give the required mechanical features or, possibly, a single thermal treatment, can be realized.

The final structure 7 can therefore be treated both in accordance with only one of the said superficial treatments and also according to a combination of two or more treatments, as described above. For that purpose, for example, FIG. 5 shows a superficial treatment of spraying followed by a thermal treatment, followed in turn by a chemical treatment.

As already said, such superficial treatments, in a particular spraying, spraying and accretion and injection of material of a polymeric nature, have the advantage of giving particular mechanical features of resistance to stresses, of hardness and/or softness of the structure 7 that they cover. It is then possible to process by machine tools an original mono-block 1 of a material of low mechanical features and low cost, such as, for example, polystyrene. In that sense, in the case of a couch, for example, the base structure 7 in polystyrene obtained as in FIG. 3 or 4 would not be able to bear the weight of the users on its own. Nevertheless, after the spraying with a suitable and particularly hard polymeric material, for example, the hardened covering 11 gives an overall rigidity to the structure 7 so as to guarantee that the structure itself can bear weights otherwise non bearable (exactly as if it had been realized in wood). Such a technique has therefore the advantage of allowing the processing of mono-blocks of a particularly soft material, easily mass-produced and of low cost.

Preferably, at the end of the productive cycle described herein, but possibly also immediately after the processing in the machine tools, a further finishing processing phase can be performed, or rather a superficial modelling or shaping, necessary to give to the structure the final shape, eliminating the roughness derived from, for example, possible thermal treatments or also from the spraying and/or injection. Without losing generality, the finishing processing can also not be performed if it were considered unnecessary.

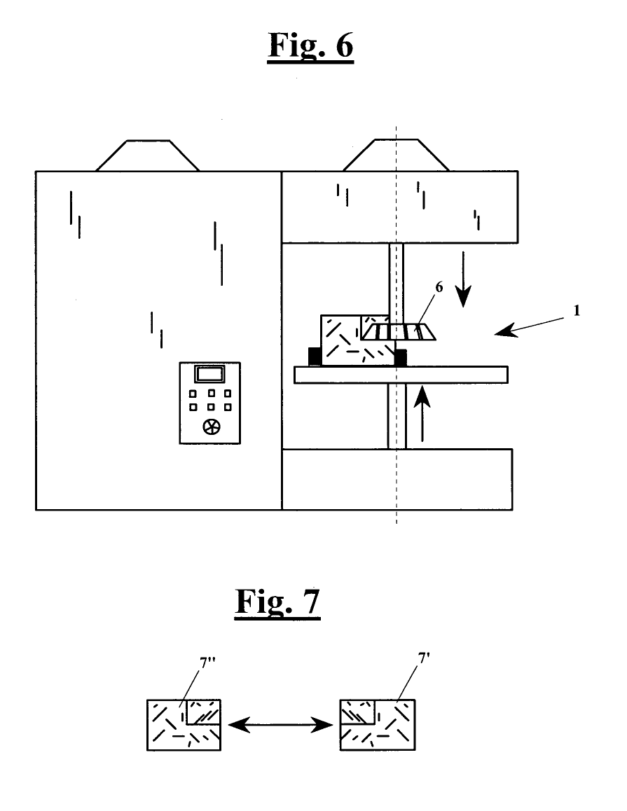

In accordance with a second embodiment of the invention (see FIG. 6), the same processing procedure by machine tools can be realized in such a way as to realize two (7′, 7″) or more parts combinable with each other in a second stage, in order to obtain then the final structure 7. FIG. 6 and FIG. 7 show, by way of example, a schematization wherein a mono-block is processed in such a way as to obtain a first half 7′ of the structure 7, and another mono-block is processed to obtain a second half 7″, which will then constitute the final structure 7.

Naturally, a single mono-block can be processed according to cycles to obtain many parts of the structure that are subsequently combinable with each other in order to obtain a final structure.

In that case, the procedure of superficial treatment previously described becomes even more important and innovative.

According to the state of the art, indeed, the production of parts configured in such a way as to be joined between them requires a choice of materials with particular mechanical resistance features and provided with joints for realizing a solid connection between the parts.

In that sense, the superficial treatment of spraying and/or spraying and accretion and/or injection solves the problem. The simple spraying indeed provides the external covering 11 that joins and consolidates the entire structure 7. A couch could be realized, for example, in many parts starting from a block in simple polystyrene, lacking joints and glueing the parts between them with a common commercial weak-seal glue. At this point, the said thermal treatment gives such hardness as to make the final structure compact and ready for use, without any break risk o need of complex and particularly resistant joints.

Also in this case, the polymeric material of the superficial treatment is identical to that of the first configuration and, possibly, has shape memory.

In both of the described configurations, naturally, the machine tools for realizing a specific processing cycle can be of different types. Without any limitation, it could be possible to use electro-mechanical machines (such as, for example, CNC machines o laser cutting ones or similar ones). In particular, such machines can produce mechanical cuts also by means of specific radiations (laser, etc.) or also high pressure liquid/gas mixtures. Moreover, for the aims that this invention attains, numerical control or control unit machines are particularly suitable, being versatile and allowing rapidly quick changeover of different processing programs, automating the cycle on the basis of the product to be processed. Indeed, the numerical control or control unit machines make simple and rapid any change in dimension or shape of the product itself, by simply setting new working coordinates.

As already said, in both of the described configurations, any type of material of the mono-block or mono-blocks can be perfectly used, without for this moving apart from the present inventive concept. Nevertheless, of particular interest for the present invention are composite materials, and in an even more particular manner, a material of the polymeric type with shape memory.

It is known already how shape memory materials have the capacity to maintain a modified shape after a forced deformation that took place above their specific glass transition temperature and subsequent “constrained” cooling. The subsequent heating above this temperature in the absence of constraints then rebuilds the original shape.

Getting even further into details, a polymer with shape memory can be heated above its specific transition temperature Tg, and once that temperature is reached, it can be deformed as required. After cooling, by maintaining it forcedly deformed (for example, by means of presses or the like), it will maintain permanently its new deformed shape. The subsequent heating above its transition temperature, without any blocking constraint, will rebuild its original shape.

It is also known how each polymeric material, on the basis of the specific chemical composition has its own mechanical features and its own distinctive temperature. In particular, the present invention preferably employs polymeric materials with memory shape that have a transition temperature at least equal or higher than 50° C. and anyway higher than the characteristic temperature of use of the product.

Thus, it is possible to use this known property of the polymeric materials with shape memory to achieve a particular expansion of the productive cycle for the realization of supporting structures, as described above.

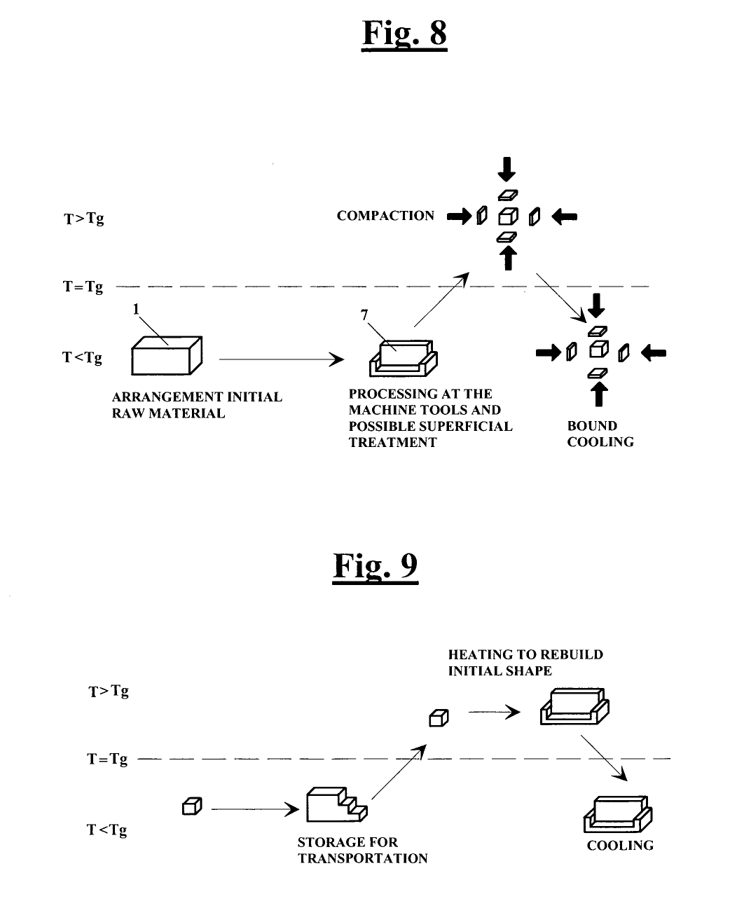

FIG. 8 schematizes the present productive cycle highlighting a hypothetical reference transition temperature (dotted line Tg). Arranging an appropriate blank 1 of polymeric material, a first step takes place comprising a normal processing cycle by machine tools, as described above and possible specific superficial treatments as required. Subsequently, a heating phase takes place above the Tg temperature with deformation according to a predetermined shape (compaction). FIG. 8 shows, by way of example, a compaction according to a cubic shape by means of a press or the like. Naturally, any other type of deformation can be achieved, without for this moving apart from the present inventive concept. At this point the cooling step follows, maintaining the constrained body in its deformed configuration always by means of a press. After reaching a temperature lower than the transition temperature, the body will maintain unchanged its new geometry (for example, cubic). It is possible at this point to achieve storage in a storehouse or transportation that involves minimal encumbrances.

When the object reaches its destination (see FIG. 9), or at any time it is necessary, it is therefore possible to proceed with heating above the Tg temperature that will allow the material to rebuild its original shape (shape memory), making it ready for all the subsequent processings and/or operations.

The invention claimed is:

1.-30. (canceled)

31. A method of producing a base structure for couches, beds, mattress/bed bases, chairs and the like comprising:
processing one or more mono-blocks in polystyrene by a machine tool according to a predetermined processing cycle to obtain a final base structure that is monolithic or two or more parts subsequently combinable to obtain the final base structure; and
performing a superficial treatment by one or more of spraying, spraying and accretion, or injection of a polymeric material to produce an external covering on the final base structure

32. The method of claim 31, wherein the spraying, spraying and accretion, or injection of the polymeric material covers only a portion of the final base structure.

33. The method of claim 31, wherein the external covering has a thickness ranging between one millimeter to 10 centimeters.

34. The method of claim 31, wherein the polymeric material is a polyurethane material.

35. The method of claim 31, wherein the injection of the polymeric material comprises the injection into at least a part of the final base structure of an expandable polymeric material such that, after expansion through porosities of the final base structure, the external covering is formed.

36. The method of claim 35, wherein the injection is performed with a syringe.

37. The method of claim 31, wherein the spraying is performed with one or more nozzles.

38. The method of claim 31, wherein the spraying and accretion is performed with a polymeric material that expands over time.

39. The method of claim 31, further comprising the step of adhesively bonding the two or more parts before the step of performing the superficial treatment such to compact the final structure.

40. The method of claim 31, wherein the step of processing by the machine tool comprises the step of:
programming a numerical control machine;
programming an electro-mechanical machine; or
applying radiation.

41. The method according to claim 31, wherein the step of processing by the machine tool comprises:
a mechanical cut operation;
a specific radiation cut operation; or
a high pressure liquid/gas mixtures cut operation.
